(19) United States
(12) Patent Application Publication
(10) Pub. No.: US 2015/0266507 A1
(43) Pub. Date: Sep. 24, 2015

(54) STEERING LOCK MECHANISM FOR HEAVY-DUTY VEHICLE AXLE/SUSPENSION SYSTEM

(71) Applicant: HENDRICKSON USA, L.L.C., Itasca, IL (US)

(72) Inventors: Andrew J. Westnedge, Granville, OH (US); James Anthony Krueger Guntermann, Columbus, OH (US); Scott A. Kohler, Danville, OH (US)

(21) Appl. No.: 14/666,405

(22) Filed: Mar. 24, 2015

Related U.S. Application Data
(60) Provisional application No. 61/969,306, filed on Mar. 24, 2014.

(51) Int. Cl. B62D 13/06; B62D 7/22

(52) U.S. Cl. CPC B62D 13/06; B62D 7/228

(57) ABSTRACT

A steering lock mechanism for a steerable axle/suspension system includes a pair of independent tie rods, each one connected to a respective one of a pair of pivoting ends of a steerable axle/suspension system and also connected to a steering bracket that is pivotally connected to the axle of the steerable axle/suspension system. A primary lock assembly, which includes an air spring, and a secondary lock assembly are operatively connected to the steering bracket and to the steerable axle/suspension system. When the air spring of the primary lock assembly is inflated with air or when the secondary lock assembly is activated, the steering bracket is prevented from pivoting and in turn the first and second tie rods are prevented from moving transversely, so that the steerable axle/suspension system is locked into a generally straight travel position during operation of the vehicle.

### CROSS-REFERENCE TO RELATED APPLICATION

This application claims the benefit of U.S. Provisional Patent Application Ser. No. 61/969,306, filed Mar. 24, 2014.

### BACKGROUND OF THE INVENTION

1. Field of the Invention

The invention relates generally to the art of heavy-duty vehicles. More particularly, the invention is directed to a heavy-duty vehicle which incorporates a steerable axle/suspension system. More specifically, the invention is directed to a steering lock mechanism for a steerable axle/suspension system of a heavy-duty vehicle that provides independent tie rods for individual wheel adjustment while in a steering mode, yet provides a primary and a secondary steering lock assembly for locking the wheels from steering while in a locked mode, which typically occurs when the vehicle is being driven or operated in a reverse direction. The steering lock mechanism for steerable axle/suspension systems of heavy-duty vehicles provides simpler individual wheel adjustment of the steerable axle, so that the steerable axle tracks properly during operation of the vehicle when the steerable axle is in contact with the ground surface and moving in a forward direction.

2. Background Art

Heavy-duty vehicles such as tractor-trailers and straight trucks typically include multiple axle/suspension systems that are longitudinally spaced along the vehicle to create ride stability. Recently, laws have been enacted in Canada which direct that non-steerable axle/suspension systems that had previously been lifted for maneuverability must now instead be steerable axle/suspension systems. That is, the axle may not be lifted for maneuverability when moving in a forward direction as was the case with liftable non-steerable axle/suspension systems, but must instead remain on the ground and steer to attain maneuverability. Such steerable axle/suspensions systems are well known in the art, and it is also well known in the art that steerable axle/suspension systems are often capable of being lifted. Hence, for the purpose of simplicity, reference herein will be made to steerable axle/suspension systems with the understanding that steerable axle/suspension systems may optionally include a lift assembly.

The actual lifting of the lift axle is performed by the transversely-spaced suspension assemblies that are associated with the lift axle, with such steerable lift axle/suspension systems being well-known in the art. The lift axle/suspension system typically is operated by a control system that is in turn actuated by a switch, commonly referred to as a lift switch, which is manually triggered by the operator of the vehicle. Lift switches traditionally have been installed in the cab of the vehicle for proximity to the operator. This prevents an operator from having to exit the cab, which can be particularly inconvenient in circumstances such as inclement weather.

In addition, the steerable axle/suspension system typically is located at about the center of the trailer in the fore-aft direction and usually uses a single tire on each of the wheels at the axle ends. Such single tires each have a large area of contact with the ground. In a tight turning maneuver, the central positioning of the steerable axle/suspension system combines with the large area of contact of the tires and the severe angle between the tractor and the trailer, thereby causing the wheels of the steerable axle/suspension system to act as a pivot point.

When the vehicle is moving or operating in a reverse direction, the steerable axle/suspension system must be either lifted or locked into a straight position in order to allow for safe maneuvering of the vehicle. If the steerable axle/suspension system is lifted while operating in a reverse direction, then once the vehicle is again moved in a forward direction, the steerable axle/suspension system usually must be lowered back into contact with the ground surface. If the steerable axle/suspension system is locked into a straight position, or locked mode, while moving in a reverse direction, then once the vehicle is again moved or operated in a forward direction, the steerable axle/suspension system should be unlocked, or placed into a steering mode, so that it can once again steer as it is intended to do while moving in a forward direction.

Prior art steerable axle/suspension systems typically provide a locking mechanism that is clamped onto a single tie rod, which extends from the pivot bracket on the driver side of the axle/suspension system to the pivot bracket on the curb side of the axle/suspension system. One such prior art locking mechanism utilizes a knuckle that contacts a plate, which is clamped onto the single tie rod. The contact pressure of the knuckle on the plate resists steering of the wheels, putting the wheels in a locked mode. This particular locking mechanism can potentially be prone to wear, as the knuckle and the contact plate can become worn over time, which can potentially lead to slippage of the steering lock mechanism resulting in unwanted steering movement of the steerable axle/suspension system. Moreover, the plate that is clamped onto the single tie rod can also potentially be prone to slippage over time because of normal wear and tear, also resulting in unwanted steering movement of the steerable axle/suspension system. Other prior art locking mechanisms for steerable axles have included a dowel that is inserted into an opening that is formed in a plate that is clamped onto the tie rod of the steerable axle. These other prior art locking mechanisms are also potentially prone to slippage at the plate to tie rod clamped connection due to wear, also potentially resulting in unwanted steering movement of the steerable axle/suspension system. Moreover, in these particular steering lock mechanisms, because the plate may potentially slip one way or the other on the tie rod, this can potentially result in failure of the dowel to properly align with the plate opening, causing the steering lock mechanism to malfunction and not properly lock. In addition, the prior art lock mechanisms described above require complicated procedures to adjust the tracking or alignment of the individual wheels of the steerable axle/suspension system in order to maintain proper alignment and tracking of the wheels mounted on the steerable axle/suspension system. More specifically, because the tie rod is singular, continuous and connected at each end to respective pivot brackets on the curb side and driver side of the steerable axle/suspension system, adjustment at the curb side wheel affects the driver side wheel and vice versa, thus complicating adjustment of alignment and tracking of the wheels of the steerable axle/suspension system.

The steering lock mechanism for steerable axle/suspension systems of the present invention overcomes the problems associated with prior art steering lock mechanisms by providing solid locking joints that are not susceptible to slippage and that are more resistant to wear and tear, resulting in a more durable steering lock mechanism. The steering lock mechanism for steerable axle/suspension systems of the present invention also provides for use of independent tie rods for each wheel, which allows easy adjustment of each wheel of the steerable axle/suspension system, thus providing easy maintenance of proper alignment and tracking of the wheels of the steerable axle/suspension system. The steering lock mechanism for steerable axle/suspension systems of the present invention also provides adjustable return force to the steerable axle, which is dependent upon the pressure in the air spring of the steering lock mechanism.

### SUMMARY OF THE INVENTION

Objectives of the present invention include providing a steering lock mechanism that is not susceptible to slippage of the linkage between the steering knuckles.

A further objective of the present invention is to provide a steering lock mechanism that is more resistant to wear and tear and, as a result, is more durable.

Another objective of the present invention is to provide a steering lock mechanism that allows easy adjustment of each wheel of the steerable axle/suspension system, thus enabling easy maintenance of proper alignment and tracking of the wheels of the steerable axle/suspension system.

Yet another objective of the present invention is to provide a steering lock mechanism that provides adjustable return force to the steerable axle, which is dependent upon the pressure in the air spring of the steering lock mechanism.

These objectives and advantages are obtained by a steering lock mechanism for a heavy-duty vehicle steerable axle/suspension system comprising; a first tie rod having an outboard end and an inboard end, the first tie rod outboard end operatively connected to a pivotable first axle end of the steerable axle/suspension system; a second tie rod having an outboard end and an inboard end, the second tie rod outboard end operatively connected to a pivotable second axle end of the steerable axle/suspension system; a steering bracket pivotally connected to the axle of the steerable axle/suspension system and pivotally connected to the first tie rod inboard end and the second tie rod inboard end; and a primary lock assembly including means for operating the lock assembly, the lock assembly operatively connected to the steering bracket and to the steerable axle/suspension system, so that when the means for operating the lock assembly is activated, the steering bracket is generally prevented from pivoting movement and the first and second tie rods in turn are prevented from moving, whereby the steerable axle/suspension system is locked into a generally straight non-steerable position during operation of the vehicle.

### BRIEF DESCRIPTION OF THE SEVERAL VIEWS OF THE DRAWINGS

The preferred exemplary embodiment of the present invention, illustrative of the best mode in which applicants have contemplated applying the principles, is set forth in the following description and is shown in the drawings, and is particularly and distinctly pointed out and set forth in the appended claims.

FIG. 1 is a schematic plan view, with hidden portions represented by broken lines, of a tractor and cab and trailer of a tractor-trailer vehicle incorporating a steerable axle/suspension system;

FIG. 2 is a schematic side elevation view of the tractor-trailer shown in FIG. 1;

FIG. 3 is a view similar to FIG. 1, but showing the vehicle making a tight left-hand turn;

FIG. 4 is a top rear perspective view of a steerable axle/suspension system;

FIG. 5 is an enlarged fragmentary top rear perspective view of the portion of the steerable axle/suspension system shown in the circled portion of FIG. 4 and marked “SEE FIG. 5”;

FIG. 6 is an enlarged fragmentary top rear perspective view of the portion of the steerable axle/suspension system shown in the circled portion of FIG. 4 and marked “SEE FIG. 6”;

FIG. 7 is a bottom front perspective view, with portions represented by broken lines, of a steerable axle/suspension system incorporating an exemplary embodiment steering lock mechanism of the present invention, showing the primary lock assembly of the steering lock mechanism pivotally attached to each one of its respective tie rods and also to the axle of the steerable axle/suspension system;

FIG. 8 is a bottom perspective view similar to FIG. 7, with the tires and wheels of the steerable axle/suspension system removed;

FIG. 9 is a top rear fragmentary perspective view, with portions represented by broken lines, of the steerable axle/suspension system shown in FIG. 7 incorporating the exemplary embodiment steering lock mechanism of the present invention, showing the secondary lock assembly mounted on the axle and the axle mount bracket and showing the pin engaging a recess formed in a secondary lock plate of the dual lock mechanism to restrict steering movement of the steerable axle/suspension system;

FIG. 10 is a greatly enlarged view of the secondary lock assembly of the exemplary embodiment steering lock mechanism of the present invention shown in FIG. 9;

FIG. 10A is a a view similar to FIG. 10, showing the secondary lock assembly disengaged from the lock plate of the steering bracket;

FIG. 11 is a greatly enlarged fragmentary view, with portions represented by broken lines, of the exemplary embodiment steering lock mechanism of the present invention, showing the axle mount bracket for the primary lock assembly mounted on the axle of the steerable axle/suspension system;

FIG. 12 is a top front perspective view, with portions represented by broken lines, of the secondary lock assembly of the exemplary embodiment steering lock mechanism shown in FIGS. 9 and 10;

FIG. 13 is a fragmentary bottom perspective view, with portions represented by broken lines, of the exemplary embodiment steering lock mechanism of the present invention, showing the steerable axle/suspension assembly in a steering mode during operation of the vehicle; and

FIG. 14 is a greatly enlarged fragmentary view of the primary lock assembly of the exemplary embodiment steering lock mechanism of the present invention shown in FIG. 13.

Similar numerals refer to similar parts throughout the drawings.

### DESCRIPTION OF THE PREFERRED EMBODIMENT

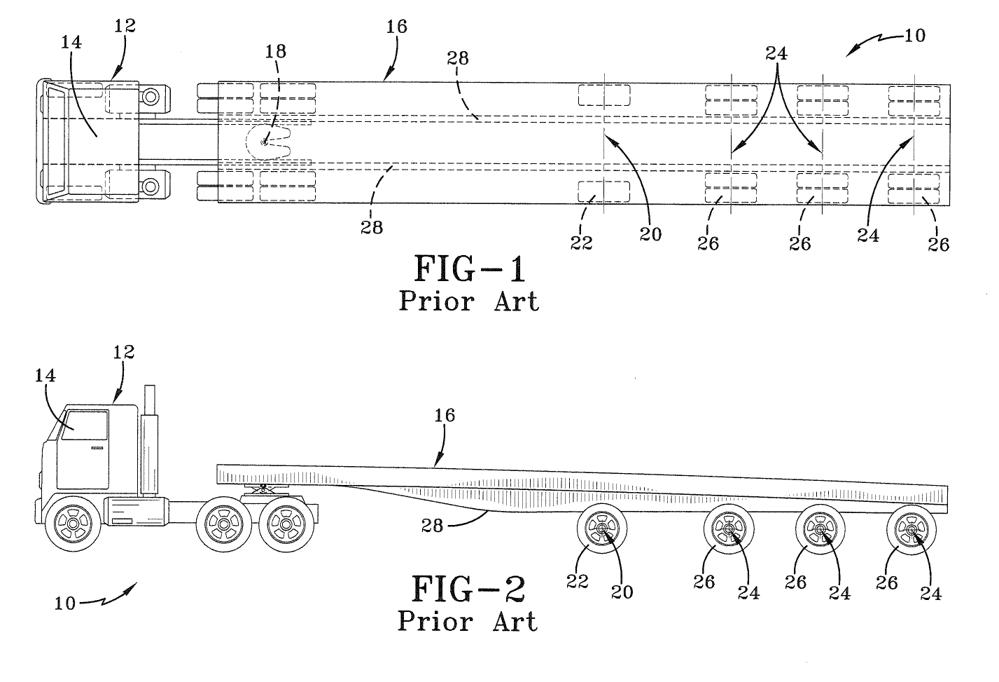

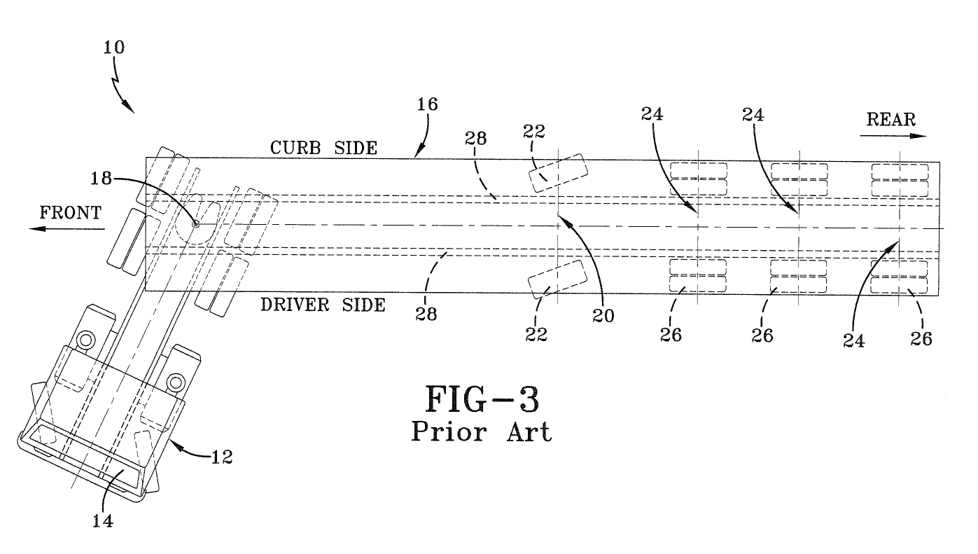

Turning now to the drawings, wherein the illustrations are provided to show the general structure of a prior art steerable axle/suspension system in order to better understand the environment in which the dual steering lock mechanism for steerable axles of the present invention is utilized, a heavy-duty vehicle is shown in FIGS. 1-2 and indicated generally at 10. Vehicle 10 includes a tractor 12 with a cab 14, and a trailer 16 pivotally connected to the cab via a kingpin 18 as known in the art. A typical steerable axle/suspension system 20 is the forward-most axle/suspension system in a group of longitudinally-spaced trailer axle/suspension systems, and a wheel assembly 22 is mounted on each end of the steerable axle/suspension system. Rearward of steerable axle/suspension system 20 are a plurality of non-steerable primary axle/suspension systems 24, on which respective wheel assemblies 26 are mounted.

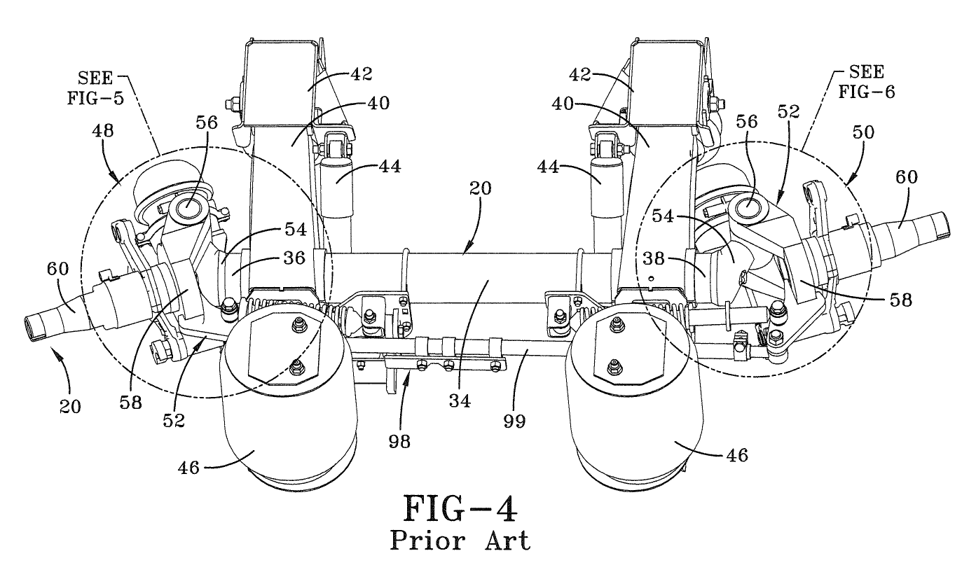

As shown in FIG. 3, when vehicle 10 makes a turn, wheels 22 on steerable axle/suspension system 20 also turn, but are limited by trailer frame rails 28 from turning to a wheel-cut angle that is greater than about twenty-eight degrees.

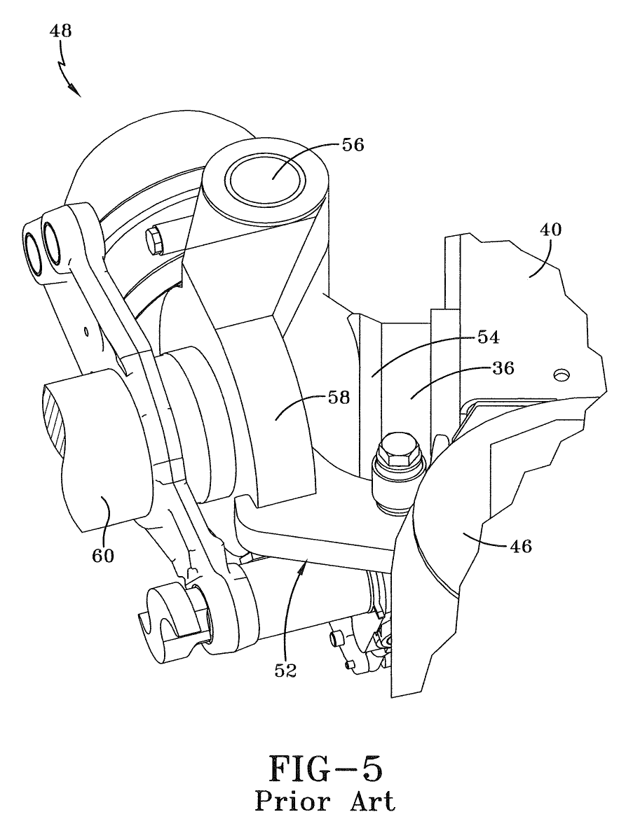

The exemplary embodiment steering lock mechanism of the present invention is utilized in conjunction with steerable axle/suspension system 20, and so that the environment in which the present invention operates can be best understood, a typical prior art heavy-duty vehicle steerable axle/suspension system is shown in FIGS. 4-6 and now will be described in detail below.

Steerable axle/suspension system 20 includes a transversely-extending central axle tube 34 that has a driver side end 36 and a curb side end 38. Central axle tube 34 is supported by a pair of transversely-spaced trailing arm beams 40, which typically are welded or otherwise rigidly affixed to the central axle tube. Each trailing arm beam 40 is pivotally attached in a well-known fashion at its front end to a respective one of a pair of transversely-spaced frame hangers 42, which in turn are rigidly attached to and depend from the frame (not shown) of the vehicle. Axle/suspension system 20 preferably also includes a pair of shock absorbers 44 and a pair of air springs 46. Each shock absorber 44 extends between and is mounted on a respective one of beams 40 and a corresponding hanger 42. Each air spring 46 extends between and is mounted on a rear end of a respective one of beams 40 and a corresponding trailer frame member (not shown).

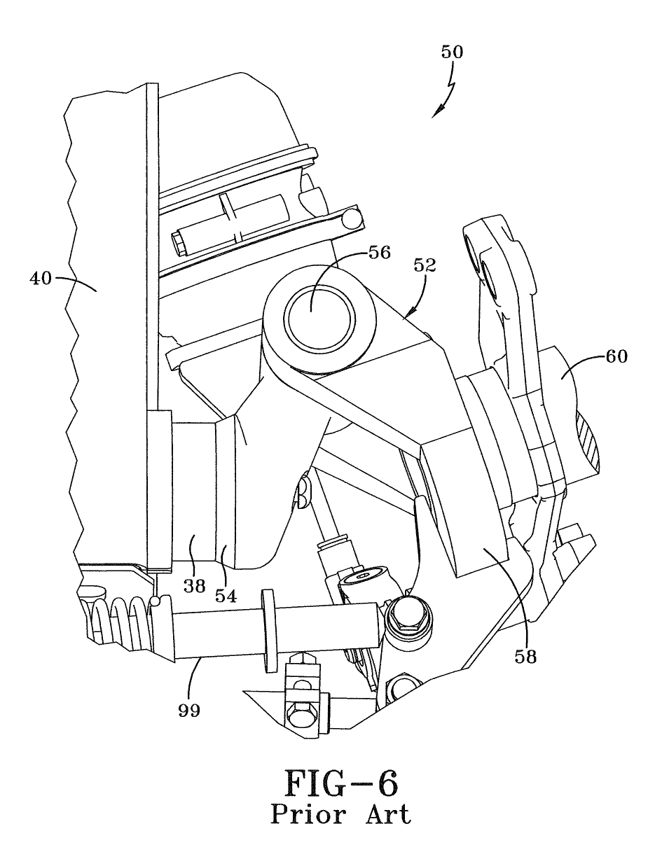

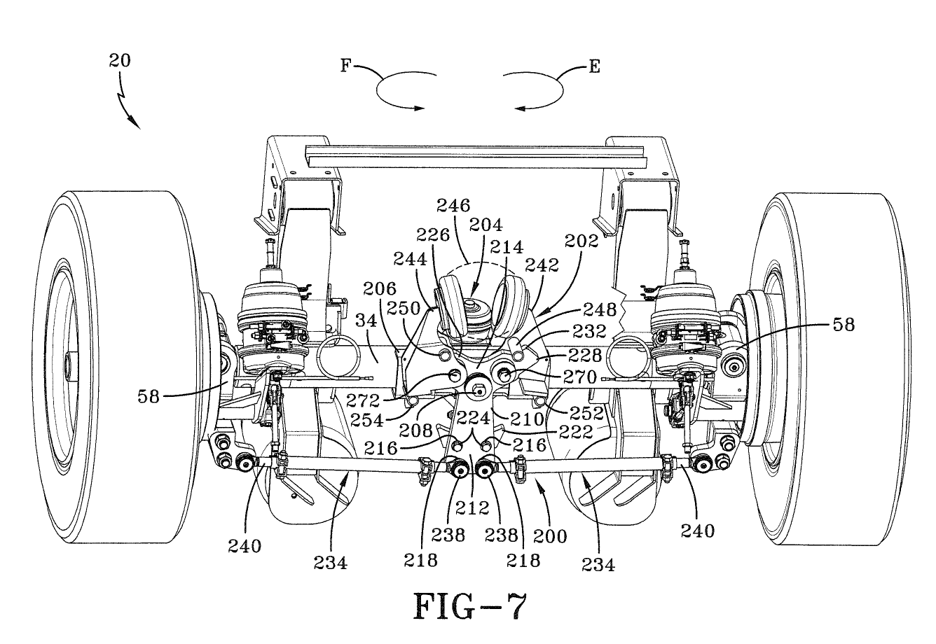

To allow the wheels attached to steerable axle/suspension system 20 to turn, the axle also includes a pair of axle ends 48 and 50, as known in the art. Driver side axle end 48 (FIG. 5) is pivotally connected to driver side end 36 of central axle tube 34, and curb side axle end 50 (FIG. 6) is pivotally connected to curb side end 38 of the central axle tube. More specifically, each one of driver side and curb side axle ends 48,50 includes a pivot assembly 52, which in turn includes a stationary portion, such as a fixed arm 54. Pivotally connected outboardly from fixed arm 54 at a main hinge point 56 is a turning wheel end or pivot bracket 58. Extending outboardly from pivot bracket 58 of each axle end 48,50 is a spindle end 60, on which a wheel (not shown) is mounted. A continuous single tie rod 99 extends between the driver side and curb side pivot brackets 58.

When the wheels mounted on steerable lift axle/suspension system 20 turn, pivot bracket 58 is caused by pivot assembly 52 to move in relation to fixed arm 54 at main hinge point 56. For example, when the wheels of steerable axle/suspension system 20 turn toward the driver's side of vehicle 10 to make a forward left turn, such as shown in FIG. 3, pivot bracket 58 of driver side axle end 48 pivots toward fixed arm 54 about main hinge point 56, while the pivot bracket of curb side axle end 50 pivots away from its corresponding fixed arm about the main hinge point, as shown in FIG. 4.

Prior art steerable axle/suspension systems such as the one described above typically provide a locking mechanism 98 that is clamped onto single tie rod 99, which extends from pivot bracket 58 on the driver side of steerable axle/suspension system 20 to the pivot bracket on the curb side of the steerable axle/suspension system. One such prior art locking mechanism utilizes a knuckle that contacts a plate, which is clamped onto the single tie rod. The contact pressure of the knuckle on the plate resists steering of the wheels, putting the wheels in a locked mode. This particular locking mechanism can potentially be prone to wear, as the knuckle and the contact plate can become worn over time, which can potentially lead to slippage of the steering lock mechanism resulting in unwanted steering movement of the steerable axle/suspension system. Moreover, the plate that is clamped onto the single tie rod can also potentially be prone to slippage over time because of normal wear and tear, also resulting in unwanted steering movement of the steerable axle/suspension system. Other prior art locking mechanisms for steerable axles have included a dowel that is inserted into an opening that is formed in a plate that is clamped onto the tie rod of the steerable axle. These other prior art locking mechanisms are also potentially prone to slippage at the plate to tie rod clamped connection due to wear, also resulting in unwanted steering movement of the steerable axle/suspension system. Moreover, in these particular steering lock mechanisms, because the plate may potentially slip one way or the other on the tie rod, this can potentially result in failure of the dowel to properly align with the plate opening, causing the steering lock mechanism to malfunction and not properly lock. In addition, the prior art lock mechanisms described above require complicated procedures to adjust the tracking or alignment of the individual wheels of the steerable axle/suspension system in order to maintain proper alignment and tracking of the wheels mounted on the steerable axle/suspension system. More specifically, because tie rod 99 is singular, continuous and connected at each end to respective pivot brackets 58 on the curb side and driver side of steerable axle/suspension system 20, adjustment at the curb side wheel affects the driver side wheel and vice versa, thus complicating adjustment of alignment and tracking of the wheels of the steerable axle/suspension system. The steering lock mechanism of the present invention overcomes these problems. The structure and operation of the steering lock mechanism of the present invention will be described in detail below.

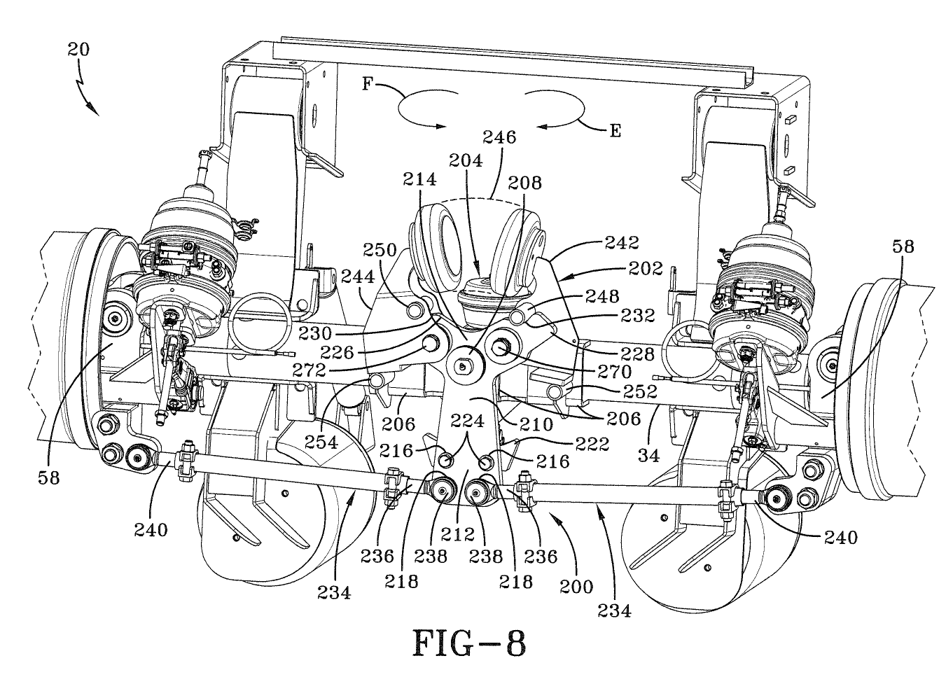

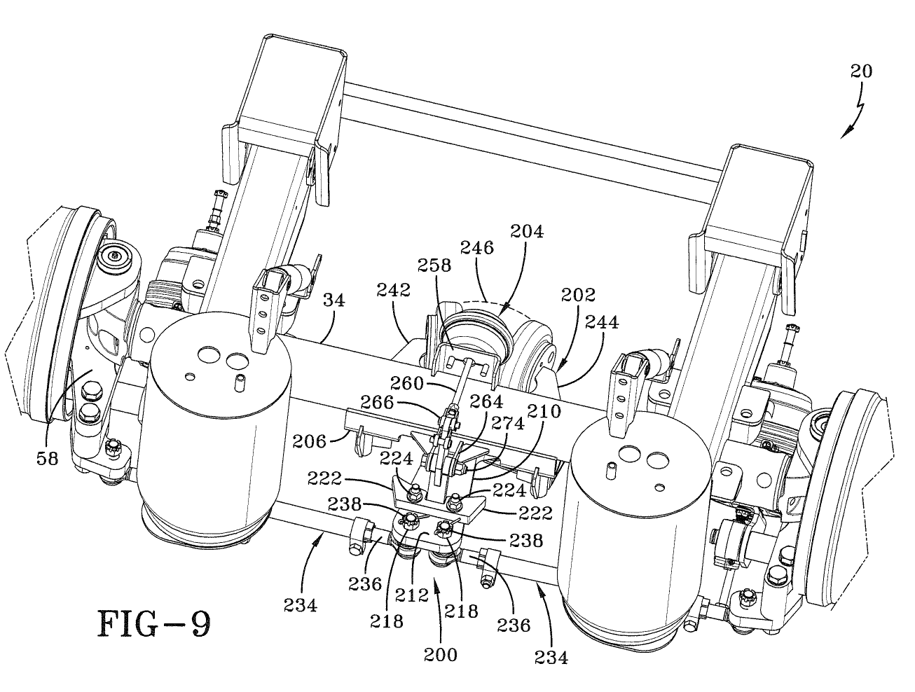

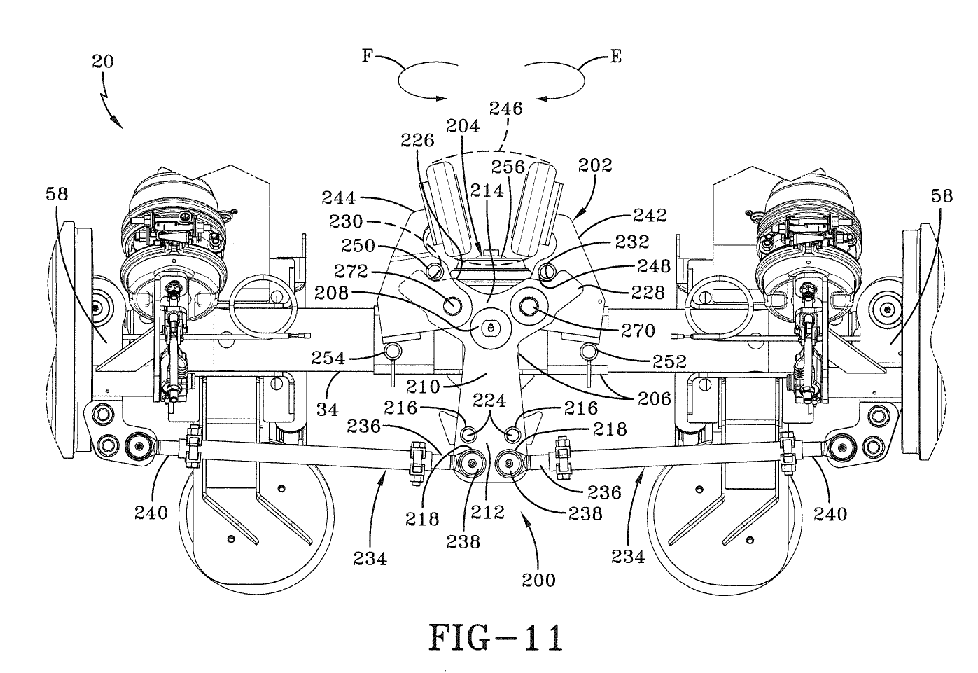

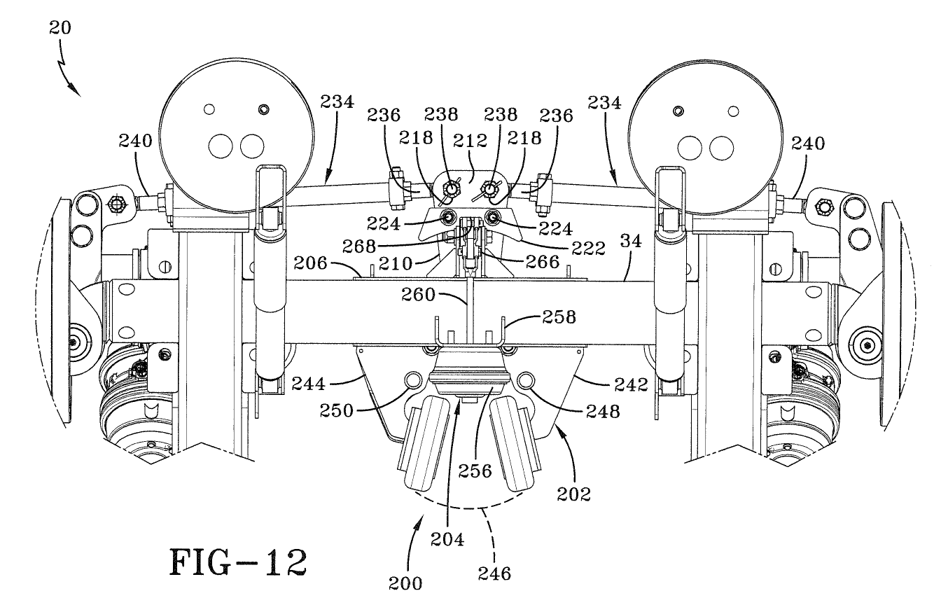

Turning now to FIGS. 7-12, an exemplary embodiment steering lock mechanism of the present invention is shown at reference numeral 200 mounted on steerable axle/suspension system 20 for heavy-duty vehicles, and now will be described in detail below.

Exemplary embodiment steering lock mechanism 200 preferably includes a primary lock assembly 202 and a secondary lock assembly 204. Primary lock assembly 202 is located generally on the bottom portion of axle 34, while secondary lock assembly 204 is located generally on the top portion of the axle.

With particular reference to FIGS. 7, 8 and 11, primary lock assembly 202 includes an axle mount bracket 206 fixedly attached generally to the bottom portion of axle 34, via welds (not shown). Axle mount bracket 206 is generally U-shaped and extends longitudinally along axle 34. Axle mount bracket 206 is formed with an opening (not shown) for alignment with a central opening (not shown) formed in a Y-shaped steering bracket 210, through which a fastener 208 is disposed in order to pivotally mount the Y-shaped steering bracket to the axle mount bracket of primary lock assembly 202. Y-shaped steering bracket 210 includes a rearwardly-extending portion 212 and a frontwardly-extending portion 214.

Rearwardly-extending portion 212 is formed with two pairs of spaced-apart openings 216 and 218, respectively. Openings 216 align with a pair of openings (not shown) formed in a lock plate 222, through which a pair of fasteners 224 are disposed in order to fixedly attach the lock plate to the top surface of rearwardly-extending portion 212 of Y-shaped steering bracket 210. Openings 218 each align with an opening (not shown) formed in an inboard end 236 of its respective tie rod 234, and a fastener 238 is disposed through each pair of aligned openings in order to pivotally connect the tie rod inboard end to Y-shaped steering bracket rearwardly-extending portion 212. An outboard end 240 of each tie rod 234 is in turn connected to its respective pivot bracket 58.

Frontwardly-extending portion 214 of Y-shaped steering bracket 210 is generally V-shaped and includes a curb side arm 226 and a driver side arm 228. Curb side arm 226 of Y-shaped steering bracket frontwardly-extending portion 214 is formed with an opening (not shown) and a recess 230. Driver side arm 228 of Y-shaped steering bracket frontwardly-extending portion 214 is formed with an opening (not shown) and a recess 232. A driver side air spring bracket 242 has a clevis-like shape and is pivotally attached to driver side arm 228 of Y-shaped steering bracket frontwardly-extending portion 214 via a fastener 270, which passes through aligned openings (not shown) formed in the driver side arm and the driver side air spring bracket. A curb side air spring bracket 244 has a clevis-like shape and is pivotally attached to curb side arm 226 of Y-shaped steering bracket front portion 214 via a fastener 272, which passes through aligned openings (not shown) formed in the curb side arm and the curb side air spring bracket. Driver side air spring bracket 242 is fixedly attached to one end of an air spring 246 in a manner well known in the art. Curb side air spring bracket 244 is fixedly attached to the other end of air spring 246 in a manner well known in the art. Driver side air spring bracket 242 includes an internal stop 248 that extends between the plates of the air spring bracket and which contacts recess 232 of driver side arm 228 of Y-shaped steering bracket frontwardly-extending portion 214. Curb side air spring bracket 244 similarly includes an internal stop 250 that extends between the plates of the air spring bracket and which contacts recess 230 of curb side arm 226 of Y-shaped steering bracket frontwardly-extending portion 214. Internal stop 250 limits counterclockwise pivoting movement F of curb side air spring bracket 244 on Y-shaped steering bracket frontwardly-extending portion 214 and resists clockwise pivoting movement E of Y-shaped steering bracket 210. Internal stop 248 limits clockwise pivoting movement E of driver side air spring bracket 242 on Y-shaped steering bracket front portion 214 and resists counterclockwise pivoting movement F of Y-shaped steering bracket 210. A driver side axle mount bracket stop 252 is mounted on the driver side portion of axle mount bracket 206. Stop 252 limits clockwise pivoting movement E of driver side air spring bracket 242 and Y-shaped steering bracket 210. A curb side axle mount bracket stop 254 is mounted on the curb side portion of axle mount bracket 206. Stop 254 limits counterclockwise pivoting movement F of curb side air spring bracket 244 and Y-shaped steering bracket 210.

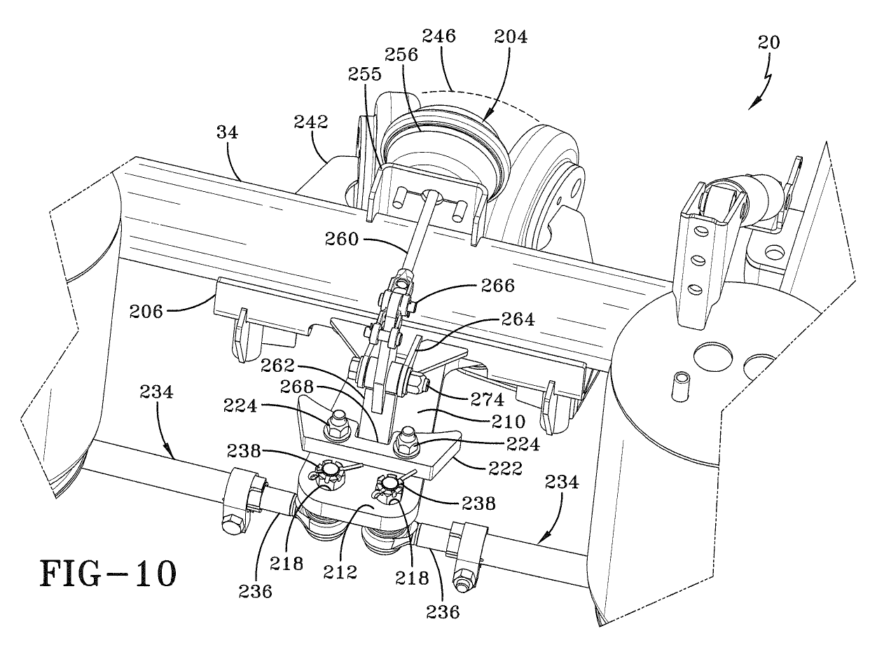

Having now described the structure of primary lock assembly 202, the structure of secondary lock assembly 204 will now be described in detail below. Turning now to FIGS. 9, 10 and 12, secondary lock assembly 204 includes a brake chamber 256 mounted generally on the top portion of axle 34 via a bracket 258, which is welded to the front portion of the axle. Brake chamber 256 includes a link 260 that extends outwardly from the brake chamber and which is moved in and out of the brake chamber when the brake chamber is activated and deactivated during operation of the vehicle. The operation of the link will be described in detail below. Link 260 is connected via a fastener 266 to a pin 262 that is pivotally mounted on a clevis 264 via a fastener 274. Link 260 is disposed generally within a recess 268 formed in lock plate 222, when link 260 is moved or retracted into brake chamber 256, as shown in FIGS. 9, 10 and 12.

Having now described the structure of primary lock assembly 202 and secondary lock assembly 204 of preferred embodiment steering lock mechanism 200 of the present invention, the operation of the primary lock assembly and the secondary lock assembly of the steering lock mechanism will be described in detail below.

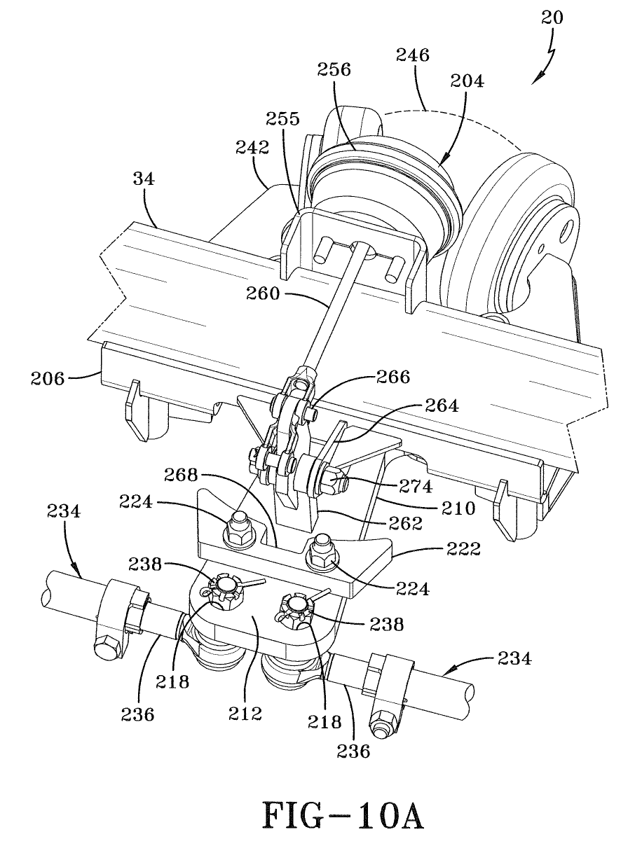

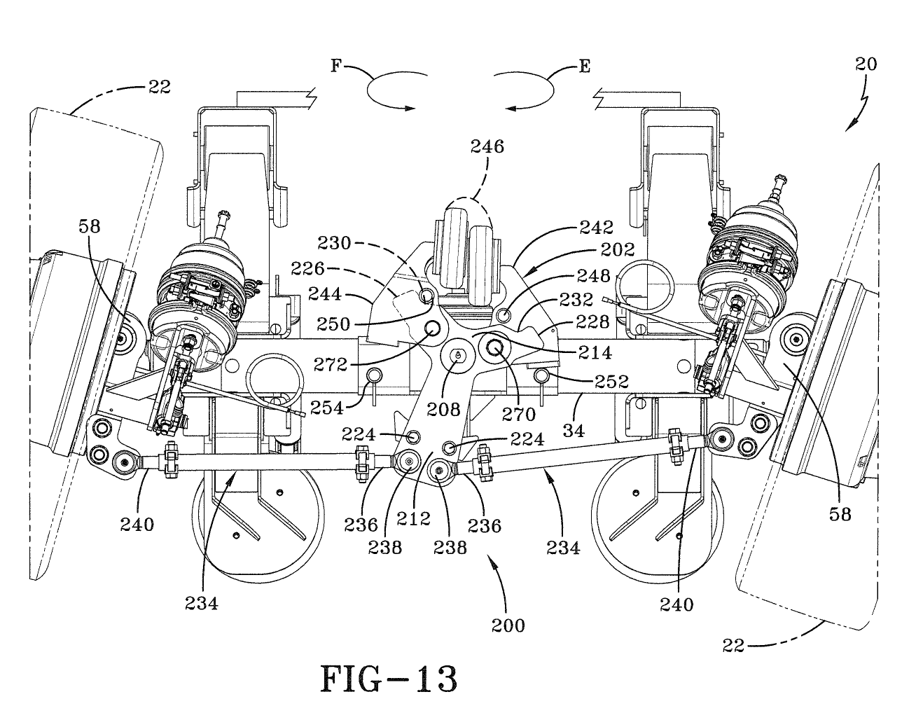

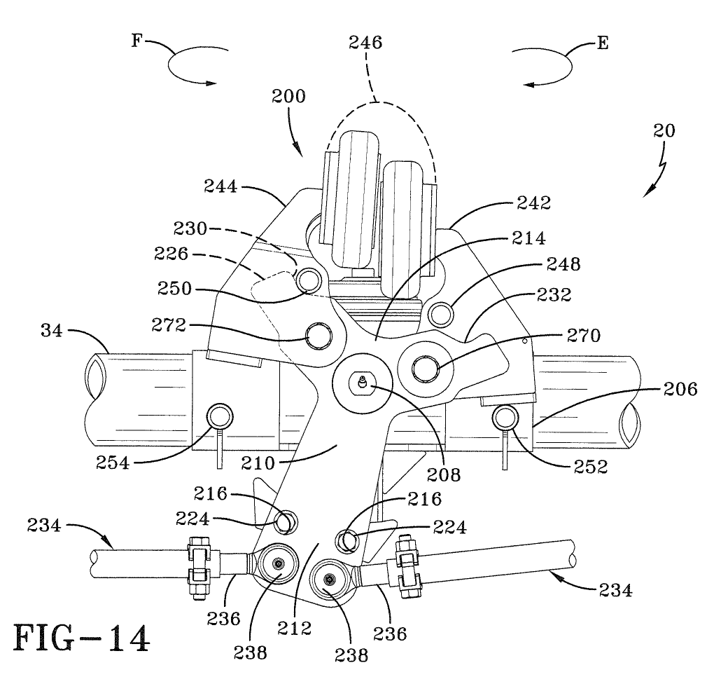

Turning now to FIGS. 13 and 14, as set forth above, primary lock assembly 202 is connected to a pair of tie rods 234 that extend between and are each connected to their respective pivot brackets 58 and also are connected to Y-shaped steering bracket 210. When vehicle 10 is being operated in a forward direction over the road and when secondary lock assembly 204 has been disengaged and steerable axle/suspension system 20 is in a steering mode, the steerable axle/suspension system steers so that the wheels turn while the vehicle is being maneuvered as shown in FIGS. 3, 13 and 14. More specifically, secondary lock assembly 204 is disengaged when pressurized air is provided to brake chamber 256, which moves or extends link 260 out of the brake chamber, which in turn moves the top portion of pin 262 in a rearward direction, causing the lower portion of pin 262 to pivot away from recess 268 of lock plate 222 (FIG. 10A). Because the lower portion of pin 262 has pivoted frontwardly away from engagement with recess 268 of lock plate 222, Y-shaped steering bracket 210 of primary lock assembly 202 is now free to pivot around central fastener 208. When vehicle 10 encounters a left-hand turn, driver side and curb side wheels 22 both pivot on their respective pivot brackets 58, which pulls and/or pushes tie rods 234 in direction D. The movement of tie rods 234 in direction D pivots Y-shaped steering bracket 210, including curb side arm 226 and driver side arm 228, in a clockwise direction E around central fastener 208, when viewed from the bottom as shown in FIG. 13. Because curb side arm 226 and driver side arm 228 are pivotally connected to curb side air spring bracket 244 and driver side air spring bracket 248, respectively, as the curb side arm and the driver side arm are rotated, the curb side air spring bracket and the driver side air spring brackets are also rotated in a clockwise direction E. When driver side air spring bracket 242 contacts driver side axle mount stop 252, clockwise movement of the driver side air spring bracket and Y-shaped steering bracket 210 is stopped, which in turn stops further steering of curb side and driver side wheels 22. Because air spring 246 is disposed between curb side air spring bracket 244 and driver side air spring bracket 248, primary lock assembly 202 provides adjustable return force to steerable axle/suspension system 20 that is dependent upon the pressure in the air spring. Because air spring 246 is disposed between curb side air spring bracket 244 and driver side air spring bracket 248, primary lock assembly 202 provides adjustable return force to steerable axle/suspension system 20 that is dependent upon the pressure in the air spring. More specifically, by increasing the internal pressure of air spring 246 the return force exhibited on the steerable axle during operation is increased. Conversely, by decreasing the internal pressure of air spring 246 the return force exhibited on the steerable axle during operation is decreased.

Likewise, when vehicle 10 encounters a right-hand turn, driver side and curb side wheels 22 both pivot on their respective pivot brackets 58, which pulls tie rod 234 opposite direction D. The movement of tie rods 234 opposite direction D pivots Y-shaped steering bracket 210, including curb side arm 226 and driver side arm 228, in a counterclockwise direction F around central fastener 208, when viewed from the bottom. Because curb side arm 226 and driver side arm 228 are pivotally connected to curb side air spring bracket 244 and driver side air spring bracket 248, respectively, as the curb side arm and the driver side arm are rotated, the curb side air spring bracket and the driver side air spring bracket are also rotated in a counterclockwise direction F. When curb side air spring bracket 244 contacts curb side axle mount stop 254, counterclockwise movement F of the curb side air spring bracket and Y-shaped steering bracket 210 is stopped, which in turn stops further steering of curb side and driver side wheels 22.

When vehicle 10 is being operated in a reverse direction, secondary lock assembly 204 is engaged and the pressure in air spring 246 of primary lock assembly 202 is increased by the operator of the vehicle, which prohibits steerable axle/suspension system 20 from steering so that wheels 22 are held straight relative to the vehicle as shown in FIGS. 9 and 10. More specifically, secondary lock assembly 204 is engaged when pressurized air is cut-off from brake chamber 256, which retracts or moves link 260 back into the brake chamber, which in turn moves the top portion of pin 262 forward, causing the lower portion of pin 262 to pivot into recess 268 of lock plate 222. Because the lower portion of pin 262 has pivoted into engagement with recess 268 of lock plate 222, Y-shaped steering bracket 210 of primary lock assembly 202 is prohibited from pivoting around central fastener 208, thereby prohibiting wheels 22 from steering and thereby locking them into a locked mode.

It should be understood that engagement and disengagement of the secondary lock assembly could be accomplished via a switch operated by the driver of the vehicle or could be automatically activated via an electronic control device, without changing the overall operation of the present invention.

Exemplary embodiment steering lock mechanism 200 of the present invention for steerable axle/suspension systems of the present invention overcomes the problems associated with prior art lock mechanisms by providing solid locking joints that are not susceptible to slippage and that are more resistant to wear and tear, resulting in a more durable lock mechanism. Steering lock mechanism 200 for steerable axle/suspension systems of the present invention also provides for the use of independent tie rods 234 for each wheel 22, which allows easy independent adjustment of the wheels of the steerable axle/suspension system, which in turn allows adjustment of one wheel without affecting the adjustment of the other wheel, thus providing easy maintenance of proper alignment and tracking of the wheels of the steerable axle/suspension system. Steering lock mechanism 200 for steerable axle/suspension systems of the present invention also provides adjustable return force to the steerable axle via air spring 246, which return force is adjustable dependent upon the pressure in the air spring of the lock mechanism. More specifically, by increasing the internal pressure of air spring 246 the return force exhibited on the steerable axle during operation is increased. Conversely, by decreasing the internal pressure of air spring 246 the return force exhibited on the steerable axle during operation is decreased.

It is understood that exemplary embodiment steering lock mechanism 200 of the present invention could be utilized in heavy-duty vehicle applications other than semi-trailers, such as on straight trucks and semi-trucks, without changing the overall concept or operation of the present invention. The concepts of the present invention also could be applied to steerable axle/suspension systems, which also are liftable. It is also understood that the present invention can be utilized on various types of steerable axle/suspension systems having various styles of beams, including leading arm, trailing arm, top mount, and bottom mount, without changing the overall concept or operation of the present invention. It should be further understood that exemplary embodiment steering lock mechanism 200 of the present invention could be automated or manually operated without changing the overall concept or operation of the present invention. It is even further understood that different shapes, materials and sizes could be utilized for the components of exemplary embodiment dual lock mechanism 200 of the present invention without changing the overall concept or operation of the present invention. It is also understood that air spring 246 of exemplary embodiment steering lock mechanism 200 of the present invention could be replaced with a spring or other known biasing means in the art, without changing the overall concept or operation of the present invention. It is understood that independent tie rods 234 of exemplary embodiment steering lock mechanism could be formed from multiple pieces without changing the overall concept or operation of the present invention.

Accordingly, the steering lock mechanism of the present invention is simplified, provides an effective, safe, inexpensive and efficient structure and method which achieves all the enumerated objectives, provides for eliminating difficulties encountered with prior steering lock mechanisms, and solves problems and obtains new results in the art.

In the foregoing description, certain terms have been used for brevity, clearness and understanding; but no unnecessary limitations are to be implied therefrom beyond the requirements of the prior art, because such terms are used for descriptive purposes and are intended to be broadly construed.

Moreover, the description and illustration of the invention is by way of example, and the scope of the invention is not limited to the exact details shown or described.

Having now described the features, discoveries and principles of the invention, the manner in which the steering lock mechanism of the present invention is used and installed, the characteristics of the construction, arrangement and method steps, and the advantageous, new and useful results obtained; the new and useful structures, devices, elements, arrangements, processes, parts and combinations are set forth in the appended claims.

What is claimed is:

1. A steering lock mechanism for a heavy-duty vehicle steerable axle/suspension system comprising;
A first tie rod having an outboard end and an inboard end, said first tie rod outboard end operatively connected to a pivotable first axle end of said steerable axle/suspension system;
A second tie rod having an outboard end and an inboard end, said second tie rod outboard end operatively connected to a pivotable second axle end of the steerable axle/suspension system;
A steering bracket pivotally connected to said axle of said steerable axle/suspension system and pivotally connected to said first tie rod inboard end and said second tie rod inboard end; and
A primary lock assembly including means for operating said lock assembly, the lock assembly operatively connected to said steering bracket and to said steerable axle/suspension system, so that when said means for operating the lock assembly is activated, the steering bracket is generally prevented from pivoting movement and the first and second tie rods in turn are prevented from moving, whereby said steerable axle/suspension system is locked into a generally straight non-steerable position during operation of the vehicle.

2. The steering lock mechanism for a heavy-duty vehicle steerable axle/suspension system of claim 1, further comprising a secondary lock assembly connected to said steerable axle/suspension system and operatively connected to said steering bracket so that said steering bracket is generally prevented from pivoting and in turn said first and second tie rods are prevented from moving transversely so that said steerable axle/suspension system is locked into a generally straight travel position when said secondary lock assembly is activated during operation of the vehicle.

3. The steering lock mechanism for a heavy-duty vehicle steerable axle/suspension system of claim 2, wherein said secondary lock assembly comprises a brake chamber rigidly connected to said steerable axle/suspension system, a link operatively connected to said brake chamber, and a pin operatively connected to said link, whereby when pressurized air is cut-off from said brake chamber, said link is retracted into said brake chamber and said pin is moved into mating engagement with said steering bracket, so that said steering bracket is generally prevented from pivoting and in turn said first and second tie rods are prevented from moving transversely so that said steerable axle/suspension system is locked into a generally straight travel position during operation of the vehicle.

4. The steering lock mechanism for a heavy-duty vehicle steerable axle/suspension system of claim 3, further comprising a lock plate connected to said steering bracket, said lock plate including a recess, wherein said pin of said second lock assembly engages said recess of said lock plate when pressurized air is cut-off from said brake chamber, so that said steering bracket is generally prevented from pivoting and in turn said first and second tie rods are prevented from moving transversely so that said steerable axle/suspension system is locked into a generally straight travel path during operation of the vehicle.

5. The steering lock mechanism for a heavy-duty vehicle steerable axle/suspension system of claim 1, whereby when said means for operating said lock assembly is deactivated, said steering bracket is generally allowed to pivot and in turn said first and second tie rods are allowed to move transversely so that said steerable axle/suspension system is allowed to steer during operation of the vehicle.

6. The steering lock mechanism for a heavy-duty vehicle steerable axle/suspension system of claim 1, wherein said steering bracket includes a generally Y-shape.

7. The steering lock mechanism for a heavy-duty vehicle steerable axle/suspension system of claim 1, wherein said means for operating said lock assembly comprises an air spring, said primary lock assembly further comprising a first air spring bracket rigidly connected to said air spring and pivotally connected to said steering bracket, and a second air spring bracket rigidly connected to said air spring and pivotally connected to said steering bracket, said air spring disposed generally between said first and second air spring brackets.

8. The steering lock mechanism for a heavy-duty vehicle steerable axle/suspension system of claim 7, further comprising a first bracket stop rigidly connected to said axle, said first bracket stop engaging with said first air spring bracket to limit pivoting movement of the first air spring bracket and in turn pivoting movement of said steering lock mechanism.

9. The steering lock mechanism for a heavy-duty vehicle steerable axle/suspension system of claim 7, further comprising a second bracket stop rigidly connected to said axle, said second bracket stop engaging with said second air spring bracket to limit pivoting movement of the second air spring bracket and in turn pivoting movement of said steering lock mechanism.

10. The steering lock mechanism for a heavy-duty vehicle steerable axle/suspension system of claim 1, wherein said steerable axle/suspension system is mounted on a heavy-duty vehicle selected from the group consisting of a truck, a trailer and a semi-truck.

11. The steering lock mechanism for a heavy-duty vehicle steerable axle/suspension system of claim 8, wherein said first bracket stop is rigidly connected to said axle via a first axle mount bracket rigidly connected to said axle and to said first bracket stop.

12. The steering lock mechanism for a heavy-duty vehicle steerable axle/suspension system of claim 9, wherein said second bracket stop is rigidly connected to said axle via a second axle mount bracket rigidly connected to said axle and to said second bracket stop.

13. The steering lock mechanism for a heavy-duty vehicle steerable axle/suspension system of claim 7, wherein said first and second air spring brackets have a generally clevis shape.

14. The steering lock mechanism for a heavy-duty vehicle steerable axle/suspension system of claim 7, wherein said first air spring bracket further comprises an internal stop that contacts said steering bracket in order to limit pivoting movement of said first air spring bracket on said steering bracket during operation of the vehicle.

15. The steering lock mechanism for a heavy-duty vehicle steerable axle/suspension system of claim 7, wherein said second air spring bracket further comprises an internal stop that contacts said steering bracket in order to limit pivoting movement of said second air spring bracket on said steering bracket during operation of the vehicle.

16. The steering lock mechanism for a heavy-duty vehicle steerable axle/suspension system of claim 14, wherein said steering bracket further comprises a generally Y-shape including a pair of outboardly-extending arms, a first recess being formed in one of said arms, said recess contacting said first air spring bracket internal stop in order to limit pivoting movement of said first air spring bracket on said steering bracket during operation of the vehicle.

17. The steering lock mechanism for a heavy-duty vehicle steerable axle/suspension system of claim 15, wherein said steering bracket further comprises a recess formed in one of said arms, said recess contacting said second air spring internal stop in order to limit pivoting movement of said second air spring bracket on said steering bracket during operation of the vehicle.

18. The steering lock mechanism for a heavy-duty vehicle steerable axle/suspension system of claim 1, wherein said first and second tie rods are separate and distinct components that provide for independent adjustment of an alignment of a curb side pivot assembly and a driver side pivot assembly of said steerable axle/suspension system.

19. The steering lock mechanism for a heavy-duty vehicle steerable axle/suspension system of claim 1, wherein said steering bracket is pivotally connected to an axle mount bracket that is rigidly connected to said axle of said steerable axle/suspension system.
